(19) United States
(12) Patent Application Publication
(10) Pub. No.: US 2008/0289020 A1
(43) Pub. Date: Nov. 20, 2008

(54) Identity Tokens Using Biometric Representations

(75) Inventors: Kim Cameron, Bellevue, WA (US); Arun K. Nanda, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/749,020

(22) Filed: May 15, 2007

(51) Int. Cl. H04L 9/32

(52) U.S. Cl. 726/9

(57) ABSTRACT

An identity system and method uses biometric representation(s) in identity tokens. When a principal requests access to a relying party, the relying party may request an identity token containing a first claim about the principal and a biometric representation of the principal. An identity provider may then create the identity token, including a digital signature. The relying party may receive the identity token through a first channel and decode it. The relying party may also receive and use biometric information about the principal received through a second channel to verify the validity of the first claim at least in part through comparison of the biometric representation to the biometric information.

### BACKGROUND

Personal identity information is helpful to service providers to ensure that goods and services are not provided to the wrong people, especially over a computer network, such as the Internet. Because the Internet is a generally anonymous forum, identity confirmation is a significant issue for service providers. For example, a vendor doing business over the Internet may want to prevent fraud by verifying the identity of someone attempting to purchase goods. Similarly, the provider of a web service that is intended only for children would want to protect against possible adult pedophiles accessing the site. As a result, many vendors and other service providers collect more information than they perhaps need in an effort to have as many points of reference as possible to prevent fraud or other wrongdoing. Many websites, for example, collect users' names, addresses, phone numbers, email addresses, and even social security numbers. In-person identification methods also often require disclosure of more than the minimum amount of information needed. For example, a shop keeper would not need to know a person's name, address, driver's license number, or even exact age if he could reliably tell that the customer was over 21 years old.

Meanwhile, many law-abiding people are becoming more wary of providing personal information to vendors or other agencies. Identity theft is becoming a common and disturbing problem, and individuals increasingly want to limit the personal information they disseminate. Moreover, many vendors do not want to collect large amounts of personal information because maintaining a large database of personal consumer information can cause significant liability if unauthorized access to that database occurs.

Moreover, forgery remains an issue. Although security measures for authenticating physical identification have improved, physical identification documents, such as drivers' licenses, have historically been subject to significant forgery problems. Automatic biometric identification systems using fingerprint scanners, iris scanners, facial feature recognition technology, etc. have been developed recently as an additional measure of security against forgery. However, these systems depend on relying parties keeping large databases of biometric information (in addition to personally identifying information) that can be queried when someone requests access to the relying party. This results in even more personal identifying information being disseminated than without biometric information testing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of an embodiment relates to a method for satisfying a security policy to access a relying party. The method includes receiving an identity token through a first channel from a principal trying to access the relying party. The identity token includes a claim, which might be a piece of personal information regarding the principal, and a biometric representation of the principal, such as a photograph. The claim and the biometric representation are bound by a digital signature. The method also includes receiving biometric information from the principal through a second channel, such as video of the principal captured through a transponder and sent in substantially real time to the relying party. The method also includes determining the validity of the claim by comparing the biometric information to the biometric representation. This may permit, for example, a relying party to determine whether a person to whom a particular claim is attributed by the identity token is the same person attempting to access the relying party.

Another aspect of an embodiment relates to a method for issuing an identity token. This method includes verifying at least a first claim about a principal. For example, an identity provider could verify that a particular individual is a certain age by reviewing the individual's driver's license and/or passport. The method also includes collecting a biometric representation of the principal, such as a photograph. Further, the method includes creating an identity token, at least in part by binding the biometric representation and the first claim together with a digital signature.

Still another aspect of an embodiment relates to a computer-readable medium having computer-executable instructions for performing certain steps. One such step includes requesting an identity token from an identity provider. The requested identity token includes at least a first claim and a biometric representation of a principal such that the two are bound by a digital signature. Another step includes sending the identity token to a relying party through a first channel. Still another step includes providing access to biometric information about the principal through a second channel.

Other aspects of other embodiments are set forth in the following Detailed Description and Claims appended hereto.

### DESCRIPTION OF THE DRAWINGS

Reference will now be made to the accompanying drawings, which are not necessarily drawn to scale and may describe particular embodiments which are not intended to be limiting in scope, and wherein:

FIG. 1 illustrates an example of a digital identity system, including an identity provider, a principal, a principal machine, and a relying party.

FIG. 2 illustrates an example method for authentication.

FIG. 3 illustrates an example of an identity token.

FIG. 4 illustrates an example of another identity system.

FIG. 5 illustrates an example method for authentication that can be used with the system in FIG. 4.

FIG. 6 illustrates an example of another identity system.

FIG. 7 illustrates an example method for authentication that can be used with the system in FIG. 6.

FIG. 8 illustrates an example of another identity system.

FIG. 9 illustrates an example method for authentication that can be used with the system in FIG. 8.

### DETAILED DESCRIPTION

Example embodiments will now be described more fully hereinafter with reference to the accompanying drawings.

Example embodiments disclosed herein relate generally to identity systems including digital identities that can be exchanged between a principal and a relying party to authenticate an identity and/or information related to the principal. In example embodiments herein, the principal is a natural person or persons. The relying party has goods, services, or other information that the principal desires to access and/or obtain. In example embodiments, the relying party can be any resource, privilege, or service that requires a security policy to enter, access, or use. For example, a relying party may comprise one or more of: computers, computer networks, data, databases, buildings, personnel, services, companies, organizations, physical locations, electronic devices, or any other type of resource.

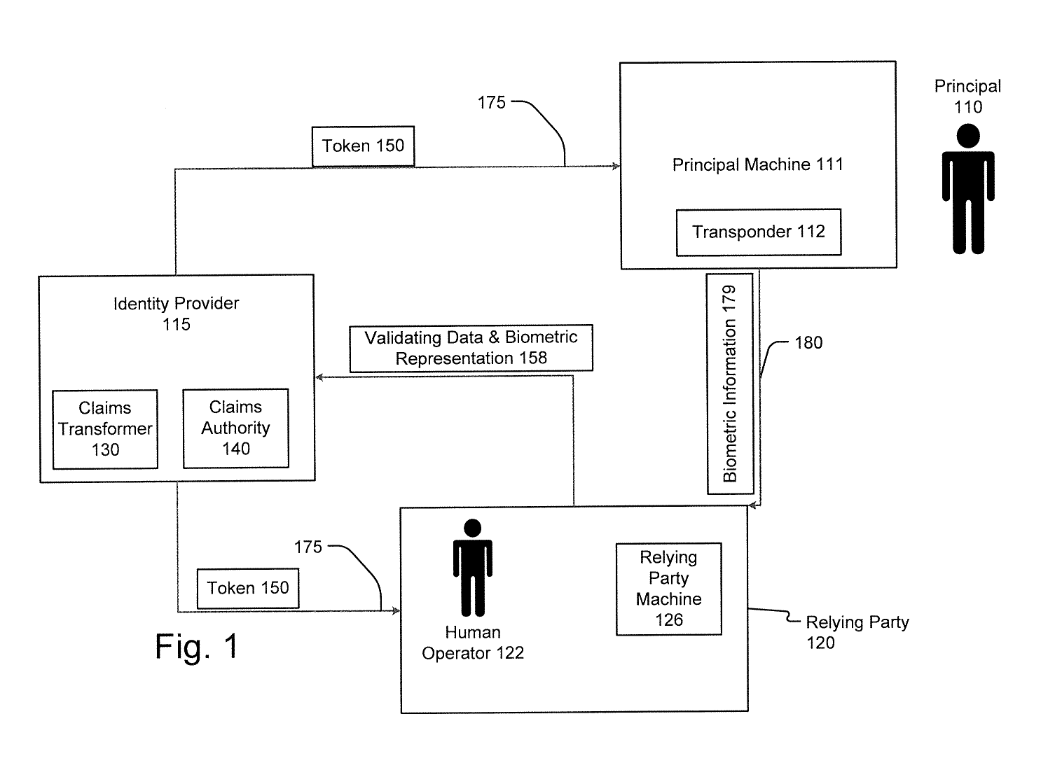

Referring now to FIG. 1, an example digital identity system 100 is shown including a principal 110 and a relying party 120. Principal 110 is in possession or control over principal machine 111. Principal machine 111 includes a computer system at least temporarily controlled by the principal. Relying party 120 may include a relying party machine 126. Relying party machine 126 includes a computer system at least temporarily controlled by the relying party 120. Relying party 120 may also include a human operator 122.

Principal 110 and relying party 120 can communicate with each other over one or more networks, such as the Internet, or through in-person, telephonic, or other forms of wired or wireless communication as described hereinafter. In example embodiments, principal 110 can request goods, services, information, privileges, or other access from relying party 120. Relying party 120 can require authentication of the identity of, or information about, principal 110 before or in conjunction with providing the requested access to principal 110.

Also shown in FIG. 1 is an example identity provider 115. Identity provider 115 includes a computer system and may also include a human operator. In example embodiments, identity provider 115 includes a claims transformer 130 and a claims authority 140. The claims transformer 130 is sometimes referred to as a “security token service.” In the example shown, identity provider 115 can provide one or more claims about principal 110. A claim is a statement or assertion made about the principal related to the principal's identity or information about the principal such as, for example, name, address, social security number, age, credit history, etc. As described further below, identity provider 115 can provide claims to principal 110 and/or relying party 120 in the form of a digitally signed security token. In example embodiments, identity provider 115 is in a trusted relationship with relying party 120, so that relying party 120 trusts the claims in the signed identity token from identity provider 115.

Although claims transformer 130 and claims authority 140 of identity provider 115 are shown as separate entities in FIG. 1, in alternative embodiments claims transformer 130 and claims authority 140 can be the same entity or different entities. Identity provider 115 may take the form of a security token service in some example embodiments.

In example embodiments, principal 110, relying party 120, and identity provider 115 can each utilize one or more computer systems. Computer systems described herein include, without limitation, a personal computer, server computer, hand-held or laptop device, microprocessor system, microprocessor-based system, programmable consumer electronics, network PCs, minicomputers, mainframe computer, smart card, telephone, mobile or cellular communication device, personal data assistant, distributed computing environment that includes any of the above systems or devices, and the like. Some computer systems described herein may comprise portable computing devices. A portable computing device is any computer system that is designed to be physically carried by a user. Each computer system may also include one or more peripherals, including without limitation: keyboard, mouse, a camera, a web camera, a video camera, a fingerprint scanner, an iris scanner, a display device such as a monitor, a microphone, or speakers. Each computer system includes one or more of volatile and non-volatile computer readable media. Computer readable media includes storage media, as well as removable and non-removable media implemented in any method or technology for storage of information such as computer readable instructions, data structures, program modules or other data. The computer system also includes communication media that typically embodies computer readable instructions, data structures, program modules or other data in a modulated data signal such as a carrier wave or other transport mechanism and includes any information delivery media. Communication media includes wired media such as a wired network or direct-wired connection, and wireless media such as acoustic, RF, infrared and other wireless media. Combinations of any of the above should also be included within the scope of computer readable media.

Each computer system includes an operating system, such as (without limitation) the WINDOWS operating system from Microsoft Corporation, and one or more programs stored on the computer readable media. Each computer system may also include one or more input and output communications devices that allow the user to communicate with the computer system, as well as allow the computer system to communicate with other devices. Communications between the computer systems used by principal 110 (e.g., principal machine 111), relying party 120 (e.g., relying party machine 126), and identity provider 115 can be implemented using any type of communications link, including, without limitation, the Internet, wide area networks, intranets, Ethernets, direct-wired paths, satellites, infrared scans, cellular communications, or any other type of wired or wireless communications.

In some example embodiments disclosed herein, system 100 is implemented at least in part as an Information Card system provided in the .NET 3.0 framework developed by Microsoft Corporation of Redmond, Wash. The Information Card system allows principals to manage multiple digital identities from various identity providers.

The Information Card system utilizes a web services platform such as the Windows Communication Framework in the .NET 3.0 framework. In addition, the Information Card system is built using the Web Services Security Specifications propagated at least in part by Microsoft Corporation of Redmond, Wash. These specifications include a message security model WS-Security, an endpoint policy WS-SecurityPolicy, a metadata protocol WS-MetadataExchange, and a trust model WS-Trust. Generally, the WS-Security model describes how to attach identity tokens to messages. The WS-SecurityPolicy model describes end point policy requirements, such as required identity tokens and supported encryption algorithms. Such policy requirements can be conveyed and negotiated using a metadata protocol defined by WS-MetadataExchange. The WS-Trust model describes a framework for trust models that enables different web services to interoperate. Some example embodiments described herein refer to the Web Services Security Specifications described above. In alternative embodiments, one or more other specifications can be used to facilitate communications between the various subsystems in system 100.

Referring again to FIG. 1, principal 110 can send a request via principal machine 111 to relying party 120 for access to goods, services, or other information. For example, in one embodiment, principal machine 111 sends a request to relying party 120 for access to information from relying party 120 that principal 110 desires. The request sent by principal machine 111 can include a request for the authentication requirements of relying party 120 using, for example, the mechanisms provided in WS-MetadataExchange.

In response to the request, relying party 120 may send principal machine 111 requirements for relying party 120 to authenticate principal's identity or other information about principal 110. The requirements of relying party 120 for authentication are referred to herein as a security policy. A security policy defines the set of claims from a trusted identity provider 115 that the principal 110 must provide to relying party 120 for relying party 120 to authenticate principal 110. A security policy can include a requirement of proof regarding a personal characteristic (such as age), identity, financial status, etc. It can also include rules regarding the level of verification and authentication required to authenticate any offers of proof (e.g., digital signature from a particular identity provider).

In one example, relying party 120 specifies its security policy using WS-SecurityPolicy, including both the claim requirements and type of identity token required by relying party 120. Examples of types of claims include, without limitation, the following: first name, last name, email address, street address, locality name or city, state or province, postal code, country, telephone number, social security number, date of birth, gender, personal identifier number, credit score, financial status, legal status, etc.

The security policy can also be used to specify the type of identity token required by relying party 120, or a default type can be used as determined by the identity provider. In addition to specifying the required claims and token type, the security policy can specify a particular identity provider required by the relying party. Alternatively, the policy can omit this element, leaving the determination of the appropriate identity provider up to principal 110. Other elements can be specified in the security policy as well such as, for example, the freshness of the required security token.

In some embodiments, principal 110 can require that relying party 120 identify itself to principal machine 111 so that principal 110 can decide whether or not to satisfy the security policy of relying party 120, as described below. In one example, relying party 120 identifies itself using an X509 certificate. In other embodiments, relying party 120 can identify itself using other mechanisms such as, for example, a Secure Sockets Layer (“SSL”) server certificate.

Principal machine 111 may include one or more digital identities for principal 110. These digital identities (sometimes referred to as “Information Cards” in the Windows Cardspace system provided in the .NET 3.0 framework developed by Microsoft Corporation of Redmond, Wash.) are artifacts that represent the token issuance relationship between principal 110 and a particular identity provider, such as identity provider 115. Each digital identity may correspond to a particular identity provider, and principal 110 can have multiple digital identities from the same or different identity providers. The use of digital identities in an identity system is described in detail in U.S. patent application Ser. No. 11/361,281, which is incorporated herein by reference as if fully set forth herein.

Digital identities can include, among other information, the identity provider's issuance policy for identity tokens, including the type of tokens that can be issued, the claim types for which it has authority, and/or the credentials to use for authentication when requesting identity tokens. Digital identities may be represented as XML documents that are issued by identity providers 115 and stored by principals 110 on a storage device such as principal machine 111.

Principal machine 111 may also include an identity selector. Generally, an identity selector is a computer program and user interface that permits principal 110 to select between one or more digital identities of principal 110 on principal machine 111 to request and obtain identity tokens from one or more identity providers, such as identity provider 115. For example, when a security policy from relying party 120 is received by principal machine 111, the identity selector may be programmed to identify one or more digital identities that satisfy one or more of the claims required by the security policy using the information in digital identities. Once principal 110 receives the security policy from relying party 120, principal 110 can communicate with (using, for example, principal machine 111) one or more identity providers to gather the claims required by the policy.

In example embodiments, principal 110 requests one or more identity tokens from identity provider 115 using the issuance mechanism described in WS-Trust. In example embodiments, principal 110 forwards the claim requirements in the policy of relying party 120 to identity provider 115. The identity of relying party 120 can, but need not, be specified in the request sent by principal 110 to identity provider 115. The request can include other requirements as well, such as a request for a display token. In example embodiments, the security policy of relying party 120 includes a requirement that the identity token returned to relying party 120 include a biometric representation 158 of principal 110. As used herein, biometric representation 158 includes any recorded or stored biometric data of or relating to a principal, including a photograph, video recording, voice recording, fingerprint, iris scan, etc. In example embodiments, the biometric representation(s) 158 of the principal 110 are captured or collected by identity provider 115.

Generally, claims authority 140 of identity provider 115 can provide one or more of the claims required by the security policy from relying party 120. Claims transformer 130 of identity provider 115 is programmed to transform the claims and to generate one or more signed identity tokens 150 that include the claim(s) and the biometric representation 158 of principal 110.

As noted above, principal 110 can request an identity token in a certain format in its request to identity provider 115, based on requirements from relying party 120. Claims transformer 130 can be programmed to generate identity tokens in one of a plurality of formats including, without limitation, X509, Kerberos, SAML (versions 1.0 and 2.0), Simple eXtensible Identity Protocol (“SXIP”), etc.

For example, in one embodiment, claims authority 140 is programmed to generate claims in a first format A, and the security policy of relying party 120 requires an identity token in a second format B. Claims transformer 130 can transform the claims from claims authority 140 from format A into format B before sending an identity token to principal 110. In addition, claims transformer 130 can be programmed to refine the semantics of a particular claim. In example embodiments, the semantics of a particular claim are transformed to minimize the amount of information provided in a particular claim and/or identity token to reduce or minimize the amount of personal information that is conveyed by a given claim.

Claims transformer 130 also binds the claim(s) and biometric representation 158 together with a digital signature. As used herein, digital signature refers to the result of any cryptographic process, algorithm, method, or system that binds pieces of digital information together via encryption. One example of a digital signature algorithm and system includes, but is not limited to, public key infrastructure (PKI) system.

In example embodiments, claims transformer 130 forwards the identity token 150 to principal 110 using the response mechanisms described in WS-Trust. In one embodiment, claims transformer 130 includes a security token service (sometimes referred to as an “STS”). In an example embodiment, principal 110 forwards identity token 150 over a first channel 175 to relying party 120 by binding identity token 150 to an to application message using the security binding mechanisms described in WS-Security. In other embodiments, identity token 150 may be sent directly from the identity provider 115 to relying party 120. In either case, the identity token 150 is sent to the relying party 120 via a first channel 175. Channels are discussed further below.

Once relying party 120 receives identity token 150, relying party 120 can verify (e.g., by decoding or decrypting the identity token 150) the origin of signed identity token 150. Relying party 120 can also utilize the claim(s) in identity token 150 to satisfy the security policy of relying party 120 to authenticate principal 110. Relying party 120 can also use the biometric representation 158 included in identity token 150 to authenticate principal 110 as described below.

Identity system 100 also includes a second channel 180 through which relying party 120 receives biometric information 179 from principal 110. Biometric information 179 includes any biometric characteristic of a principal that can be transmitted via a transponder over a communication link or observed through in-person observation, including: visual features (hair and eye color, height, weight, apparent age, etc.), audio features (sound of principal's voice), or manual/machine examined features (fingerprints, iris characteristics, etc.). In an example embodiment, principal machine 111 may be equipped with a transponder 112 to capture biometric information 179 from principal 110. For example, transponder 112 may be a web camera that can capture video of the principal 110, which can be transmitted to relying party 120. Transponder 112 may also include a microphone, an iris scanner, a fingerprint scanner, or any other device sufficient to capture biometric information 179. Biometric information 179 can be transmitted from transponder 112 to relying party 120 via a second channel that is different from the first channel 175 by which token 150 is sent.

As used herein, a “channel” refers to the manner in which information at issue is collected and is received by relying party 120. The distinction between different channels in identity system 100 is a logical one. Two distinct channels could employ some or all of the same physical or electronic communication link or different paths altogether. For example, identity token 150 could be sent over the same communication link (e.g., the Internet) as the video of the principal, but the channels are logically different (e.g., one is a stored representation originating at an identity provider, one is live information captured through a transponder). In another example embodiment, first channel 175 is electronic communication link, and second channel 180 is face-to-face observation.

In example embodiments, relying party 120 may include a human operator who can review both the biometric representation 158 in the identity token 150 and the biometric information 179 received through the second channel 180. If the biometric representation 158 and the biometric information 179 sufficiently match, the human operator at relying party 120 may authenticate the principal 110 and the claim(s) contained in the identity token 150 and permit access to the relying party 120. Once authentication is complete, relying party 120 can provide access to the goods, services, or other information requested by principal 110.

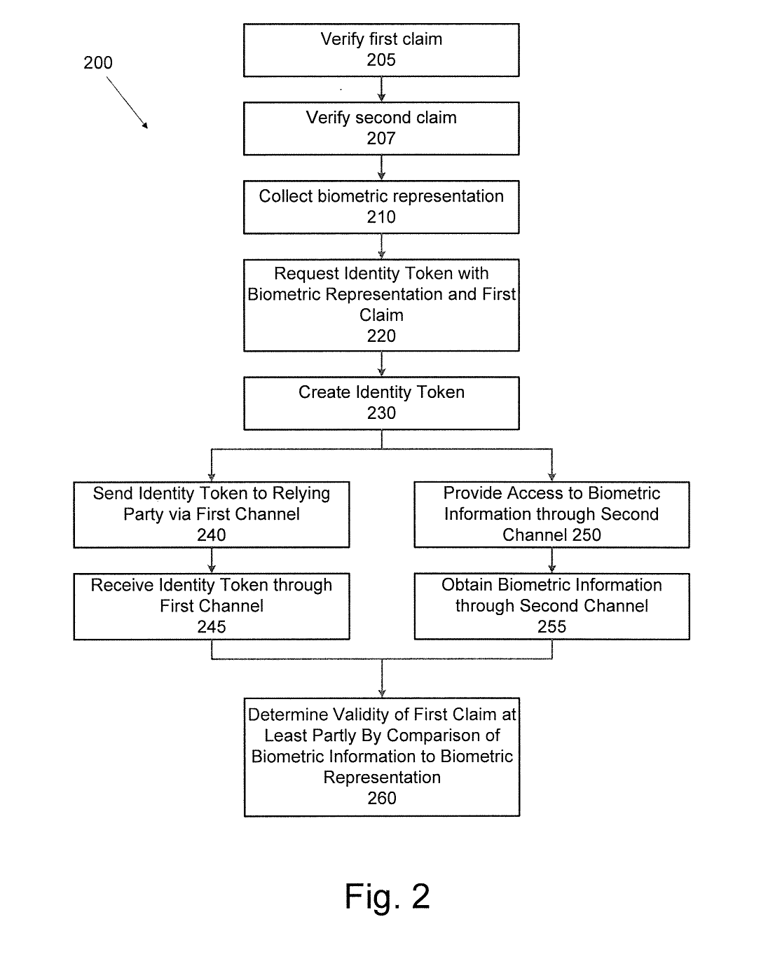

Referring now to FIG. 2, an example method 200 is shown. At operation 205, an identity provider verifies a first claim about a principal. For example, a principal may present a human operator at an identity provider (such as a bank or government agency) with physical documents (e.g., driver's license, passport, etc.) to validate a claim, such as the principal's birth date. Identity provider may also verify a second claim 207, such as the principal's social security number. The identity provider then collects 210 a biometric representation of the principal. For example, an identity provider may take a picture or video of the principal. Alternatively, the identity provider may ask the principal, without limitation, to provide a voice sample or to submit to a fingerprint scan or iris scan. The identity provider may then store both the biometric representation and the data comprising the first and second claims.

At operation 220, the identity provider is requested to provide an identity token with the first claim and the biometric representation digitally signed together. The identity provider may not be requested to include the second claim. The identity provider creates 230 the identity token with the biometric representation and first claim and digitally signs the information in the identity token. In some example embodiments, identity provider may create 230 the identity token prior to the identity token being requested 220.

At operation 240, the identity token is sent to the relying party through a first channel. For example, an identity provider may send an identity token to the principal, which forwards the identity token to the relying party. In another example embodiment, the principal may direct the identity provider to send the identity token directly to the relying party. The identity token, including the biometric representation and the first claim, is received 245 through the first channel by the relying party.

Because the identity token is digitally signed by an identity provider that is in a trusted relationship with the relying party, the relying party is assured that the first claim is true with regard to the person represented by the biometric representation. However, without verification of that the person attempting to access the relying party is the same person as represented in the biometric representation, the relying party cannot be certain that a fraud is not being perpetrated. For example, if a wrongdoer obtained access to someone else's digital identity and any associated passwords, the relying party would have no way of verifying that it was providing access to the right person.

At operation 250, the relying party is provided access to biometric information through a second channel. For example, a principal may provide access for a relying party to biometric information by turning on a web camera that will capture video of the principal. In other example embodiments, the principal may submit to a voice test, an iris scan, a fingerprint scan, an in-person examination, or other biometric testing or examination. The biometric information is obtained 255 by the relying party through the second channel. For example, where the biometric information is video of the principal, the biometric information may be obtained by the relying party by displaying the video of the principal on a monitor for viewing by a human operator at the relying party. Any of operations 250 and 255 can be performed prior to, after, or in parallel with, operations 240 and 245.

At operation 260, the validity of the first claim is determined by the relying party at least in part by comparing the biometric representation to the biometric information. In an example embodiment, the biometric information is a photograph, the biometric information is video, and the first claim is that the principal is over 21 years of age. In this example, the relying party may, for example, compare the video and the photograph to confirm that the same person who the identity provider verified as being over 21 years of age is the person currently trying to access the relying party.

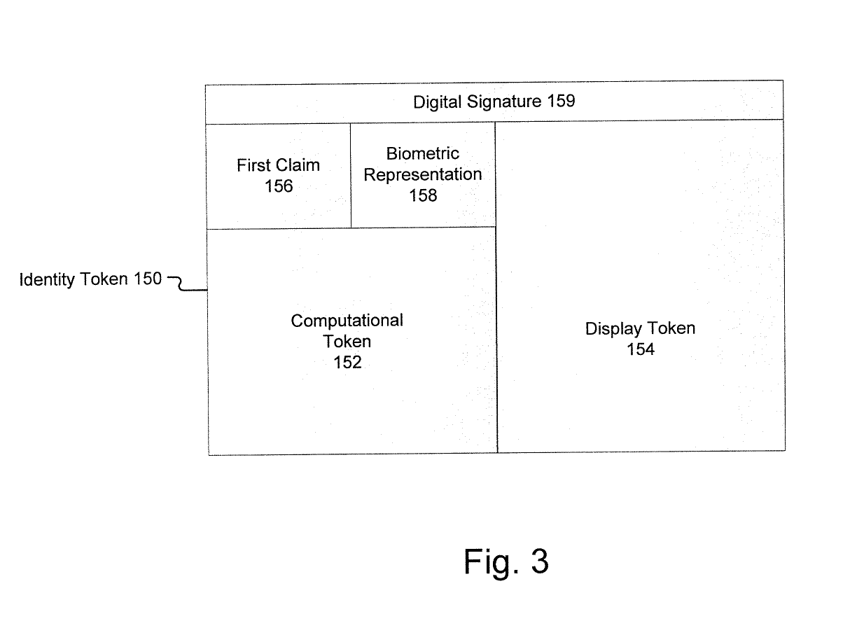

FIG. 3 illustrates an example embodiment of an identity token 150. Identity token 150 may include a computational token 152 and a display token 154. Computational token 152 includes the claim(s) and biometric representation provided by identity provider 115 in an encrypted format. Claims transformer 130 generates computational token 152 in an encrypted format that can be understood (i.e., decrypted) by relying party 120. In example embodiments, the computational token includes both a first claim 156 regarding the principal 110 and a biometric representation 158 of the principal 110.

Claims transformer 130 may also generate a display token 154. Generally, display token 154 includes at least a summary of the claims that are included in computational token 152 of identity token 150 and the biometric representation 158 of principal 110. For example, in some embodiments, display token 154 includes a list of all of the claims included in computational token 152 plus a picture of principal 110. Display token 154 can be generated in a format that can be reviewed by principal 110 (e.g., using principal machine 111) and/or relying party 120 (e.g., using relying party machine 126).

In some embodiments, identity token 150 including computational token 152 is issued in accordance with the SAML standard. For example, identity token 150 can be issued in accordance with SAML 1.1 or SAML 2.0 standards. Other standards can also be used such as, for example and without limitation, an X.509 certificate and a Kerberos ticket.

In addition, identity token 150 can be cryptographically signed or endorsed by claims transformer 130 using a known algorithm to create a digital signature 159. In one embodiment, for example and without limitation, a 2048-bit asymmetric Rivest-Shamir-Adleman (“RSA”) key is used. In other embodiments, other encryption algorithms can be used such as, for example, an Advanced Encryption System (“AES”) symmetric encryption key. In one embodiment, a symmetric key is used by default. In this manner, in the example shown, a party such as relying party 120 can cryptographically verify that identity token 150 originated from identity provider 115.

In example embodiments, identity token 150 is cryptographically endorsed by digitally signing the entire response message from the identity provider containing both the computational token 152 and the display token 154. In this manner, the first claim 156 and biometric representation 158 are cryptographically bound together, as is the computational token 152 bound to the display token 154. In addition, a party such as the relying party 120 can cryptographically verify that the first claim 156 and biometric representation 158 were linked by identity provider 115 and have not been compromised.

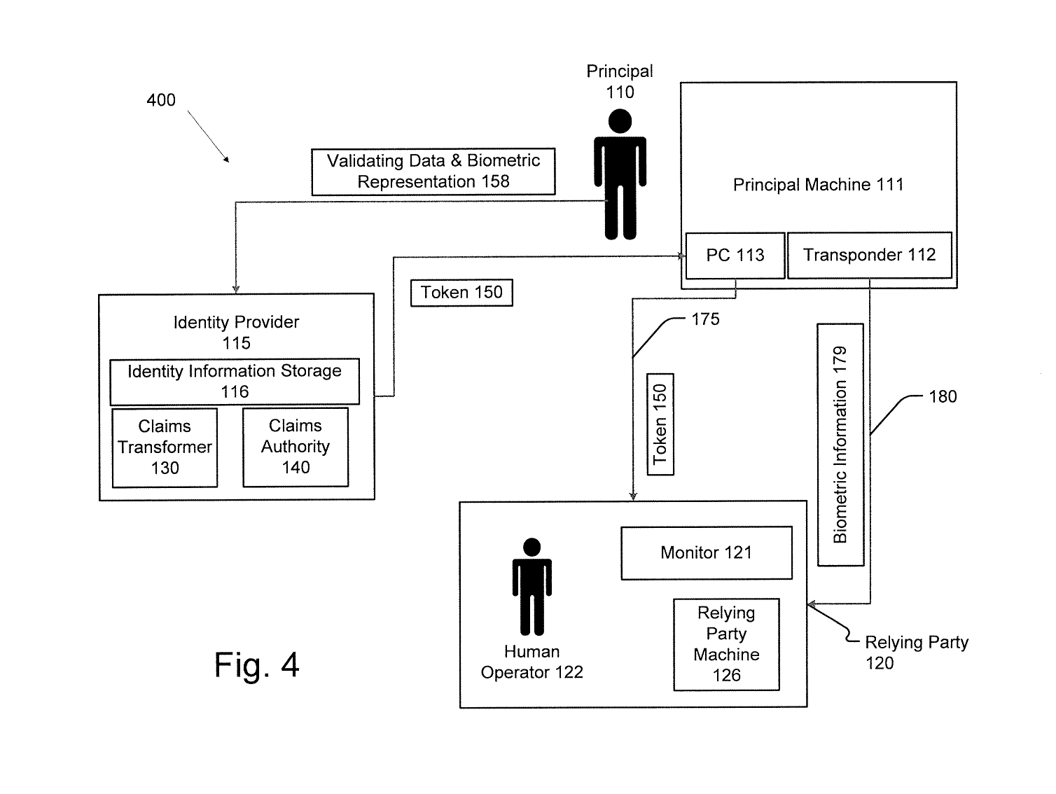

Referring now to FIG. 4, an example identity system 400 is illustrated. In this nonlimiting example, principal machine 111 includes a personal computer 113 and a transponder 112, such as a web camera. Resource 120 includes a relying party machine 126 (in this case, a web server), a human operator 122, and a monitor 121. Identity provider 115 includes a claims transformer 130, claims authority 140, and identification information storage 116. Principal machine 111, relying party 120, and identity provider 115 all communicate in this example over the Internet.

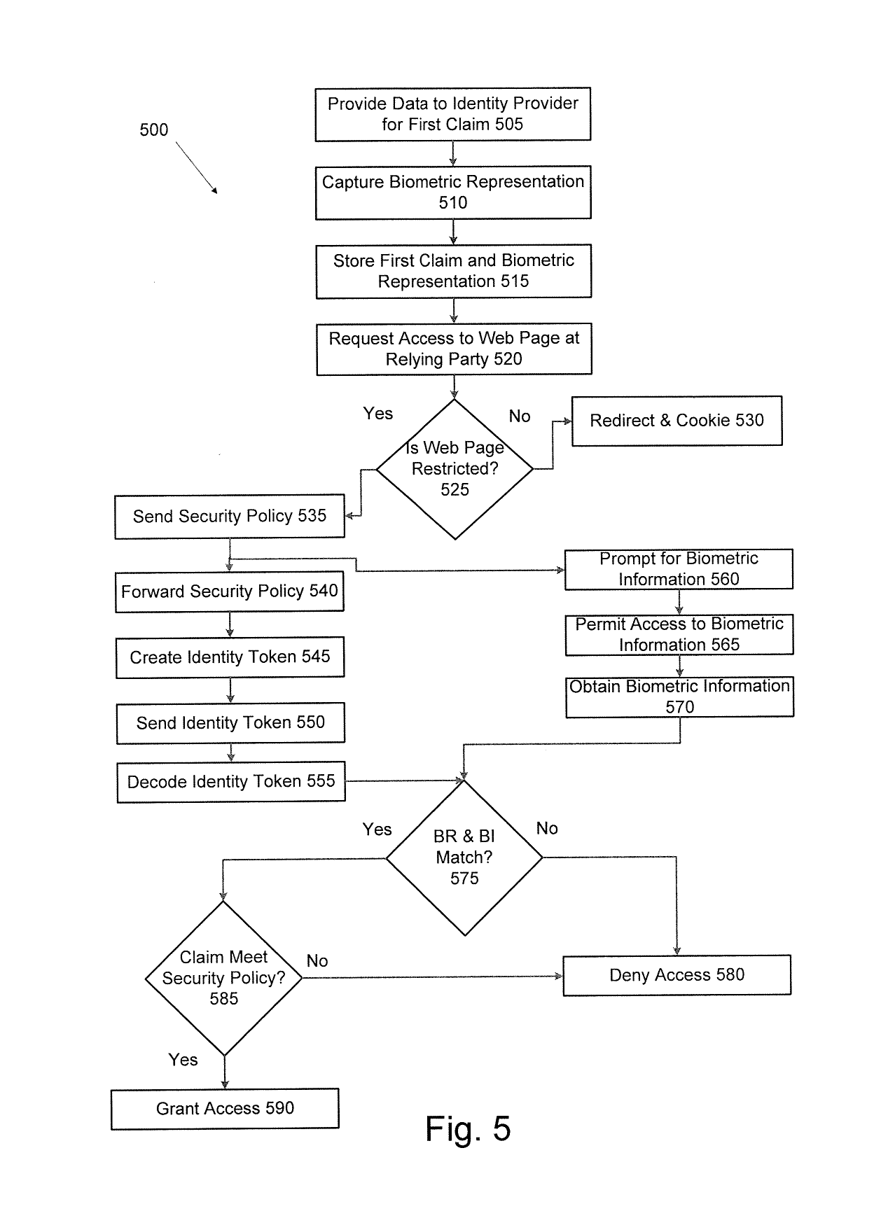

Referring now to FIG. 5, an example method 500 is shown with regard to the example system 400 shown in FIG. 4 and example identity token shown in FIG. 3. In this example, a principal 110 attempts to access a restricted web site at relying party 120. Relying party 120 has a security policy requiring that a party requesting access must be under 18 years old (for example, to access a children-only chat room) and must provide: (a) an identity token from identity provider 115 that includes a picture of the principal and a verified claim that the principal is under 18 years old; and (b) live video of the principal transmitted to the relying party.

Pursuant to the nonlimiting example recited above, principal 110 provides 505 data to the identity provider 115 to validate a first claim 156. For example, the principal may be a student at a school, and the school in this case may be the identity provider 115. The student could present himself or herself to a representative of the school along with identifying documentation that would include his/her birth date. The identity provider 115 then captures a biometric representation of the principal 110, the student in this case. In this example, a representative of the school may take a picture of the student. The identity provider 115 then stores 515 at least the biometric representation and the information supporting the first claim 156 (in this case the picture of the student and the student's birth date) in identity information storage 116. In this example, operations 505, 510, and 515 can be done at any time prior to the identity provider 115 furnishing identity token 150.

When principal 110 is ready to access relying party 120, principal 110 requests access 520 to the desired web page at relying party 120. This can be accomplished via HTTP/GET. The relying party machine 126 determines 525 if access to the requested page is restricted. If it is not, the internet browser on personal computer 113 is sent a cookie and browser redirect 530 via, for example, HTTP(S)/POST, and principal is permitted access to the web page. If the web page is restricted, the relying party machine 126 sends 535 the applicable security policy to principal machine 111 and redirects the browser at personal computer 113 to a login page. Personal computer 113 responds with an HTTP/GET for the login page, and relying party machine 126 sends the login page to personal computer 113.

The login page may include HTML tags that invoke an information card application on the personal computer. For example, if the personal computer 113 utilizes the Windows CardSpace system available from Microsoft Corporation of Redmond, Wash., HTML tags from relying party machine 126 could invoke an instance of Windows CardSpace on the personal computer 113. The principal 110 would then be prompted to choose from stored information cards that would meet the security policy forwarded by relying party machine 126.

Personal computer 113 forwards 540 the security policy to identity provider 115 and requests an identity token 150 to comply with the security policy. In this example, the identity token is required to contain a picture of the principal 110 digitally signed with a claim that the principal 110 is less than 18 years old. If the principal is employing Windows CardSpace, this is accomplished by selection of an information card, causing personal computer 113 to request a token from identity provider 115 via identity metasystem protocols, such as WS-MetadataExhange and WS-Trust propagated at least by Microsoft Corporation of Redmond, Wash.

Identity provider 115 creates 545 an identity token 150, including digitally signing the biometric representation 158 of principal 10 and the first claim 156. In this example, the claims authority 140 of identity provider 115 accesses identity provider storage 116, creates a computational token 152, including at least the picture of the student and the claim the student's birth date. Claims transformer may then transform the information regarding the student's birth date into a more specific, and less revealing, claim to meet the security policy of relying party machine 126. For example, claims authority 140 may be programmed to provide a claim of the actual birth date of principal 110 (e.g., “Birth Date=Jan. 1, 1995”). When this claim is provided to claims transformer 130, claims transformer 130 transforms the semantics of the claim from the actual birth date of principal 110 to a claim that principal 110 is under 18 years of age (e.g., “Age<18=TRUE”). In this manner, when this claim is packaged into identity token 150, less personal information about principal 110 is shared with relying party 120, while the requirements of relying party 120 are still met.

Identity provider 115 then digitally signs the token such that the pieces of information contained therein (e.g., the computational token 152, the display token 154, the biometric representation 158 and the first claim 156) cannot be dissociated from each other. Identity provider 115 then sends 550 the token 150. In this example, the identity provider 115 sends the token 150 back to personal computer 113, which forwards the token 150 to relying party machine 126 (e.g., via HTTP/POST) via first channel 175. In some example embodiments, the principal 110 may be permitted to review the content of token 150 before deciding whether to send token 150 to relying party machine 126, thereby providing principal 110 more control over dissemination of his/her personal information. In other example embodiments, principal 110 may direct the token to be sent directly to relying party machine 126 or forwarded automatically by personal computer 113 without review by principal 110. Relying party machine 126 decodes 555 the token 150 to access the first claim and biometric representation.

Principal 110 is also prompted 560 to provide biometric information 179 to the relying party by a second channel 180. In this example, biometric information 179 comprises a live video feed of the principal 110 captured via a transponder 112, such as a web camera. Principal could be prompted, for example, via the login page to the restricted web page on relying party machine 126 to start a live video feed to the relying party 120. Principal 110 then permits 656 the relying party 120 access to biometric information 179 by, for example, turning on his/her transponder 112 to start the video feed.

Relying party 120 then obtains 570 the biometric information 179 via the second channel 180. In this example embodiment, relying party 120 includes a human operator 122 with a monitor 121 to receive the video feed from transponder 112. Biometric information 179 from transponder 112 to monitor 121 could be sent over the same Internet connection used by personal computer 113 and relying party machine 126 or over a different communications link. In addition, monitor 121 can receive the biometric information 179 from transponder 112 through relying party machine 126 or any other device that is adapted to receive the biometric information 179 propogated by transponder 112. In other example embodiments, some or all of operations 560, 565, and 570 can be performed prior to, following, or in parallel with operations 535, 540, 545, 550, and 555.

In the embodiment illustrated in FIGS. 4 & 5, the first channel 175 and second channel 180 may share the same communication link between principal machine 111 and relying party machine 126. For example, the security token 150 may be sent by principal machine 111 through first channel 175 over the Internet to relying party machine 126. Similarly, biometric information 179 may be transmitted, at least in part, over the same Internet connection between principal machine 111 and relying party machine 126. The first channel 175 and second channel 180, however, are still distinct. First channel 175, for example, is a conduit for the digital information contained in security token 150, which originates at identity provider 115 and is passed through, in this example, principal machine 111 to relying party machine 126. The second channel 180, by contrast, uses a transponder to capture substantially real-time biometric information 179, which is transmitted over the Internet to relying party machine 126.

As a further security step, in order to ensure that a principal 110 is providing substantially live biometric information 179 (as opposed to recorded information relating to someone else), relying party 120 could require principal 110 to perform some unexpected action. For example, human operator 122 could tell principal 110 (through a microphone/speaker connection, instant message session, etc.) to raise his/her right arm. If principal 110 performs the action in a timely fashion, the relying party 120 has greater confidence that the biometric information 179 is being provided substantially in real time.

At operation 575, relying party 120 determines whether the biometric representation 158 contained in the identity token 150 sufficiently matches the biometric information 179 obtained by the relying party. In the example described, the human operator 122 compares the picture of the student in the identity token to the video of the principal 110. If the picture does not match the person in the video feed, the human operator 122 denies access 580. If the biometric information 179 and biometric representation 158 do sufficiently match, then the relying party 120 determines 585 whether the first claim contained in the identity token 150 is sufficient to meet the security policy for relying party 120. In the example discussed above, relying party 120 determines whether the first claim 156 confirms that the principal 110 is under 18 years old. If so, access is granted 590. Otherwise, access is denied 580. A determination whether the first claim meets the security policy of relying party 120 can be done either automatically by relying party machine 126 (by decoding the computational token 152) or by human operator 122 (by review of the display token 154) or otherwise. In other embodiments, operations 585 and 575 may occur in a different order or in parallel with each other.

In addition, other example embodiments may include the ability for other users of relying party machine 126 to deny access to principal 110. For example, principal 110 attempts to access a chat room hosted by relying party machine 126 according to the method 500 described above. In this example, however, relying party 120 does not include a human operator 122. Rather, principal 110 is permitted access to the chat room hosted by relying party machine 126 if the first claim 156 satisfies the security policy (e.g., that he/she is under 18 years old). The biometric representation 158 of principal 110 (e.g., his/her picture contained in identity token 150) is displayed in the chat room. In addition, other users of the chat room can view the biometric information 179 (e.g., video) of principal 110 captured via transponder 112. If another user of the chat room notices that the biometric information 179 does not match biometric representation 158, that other user could be provided the ability to terminate or deny access to the chat room by principal 110. In this way, no human operator 122 is required, and the relying party 120 utilizes a community within the relying party 120 to perform the comparison between biometric information 179 and biometric representation 158.

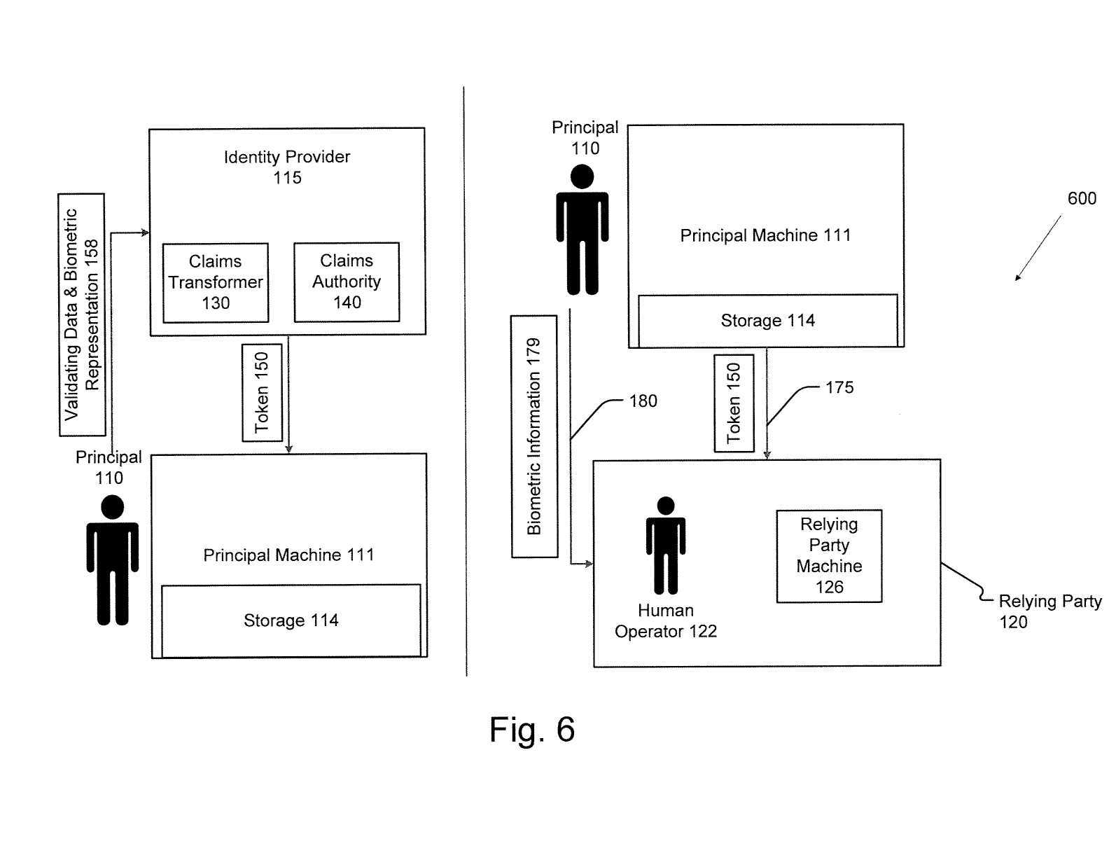

Referring now to FIG. 6, another example identity system 600 is illustrated. In this example, principal machine 111 includes storage 114 to store token 150 provided by identity provider 115. In this example, principal machine 111 comprises a smart card or other portable computing device. Relying party 120 in this nonlimiting example is a physical location that provides a restricted service. Relying party 120 includes a human operator 122 and a relying party machine 126. Relying party machine 126 may be any computing device necessary to carry out the tasks set forth herein, such as a personal computer, including peripherals such as a monitor, scanner, infrared communication capability, etc. In this example, second channel 180 comprises in-person observation of the principal 110 by relying party 120 to collect biometric information 179.

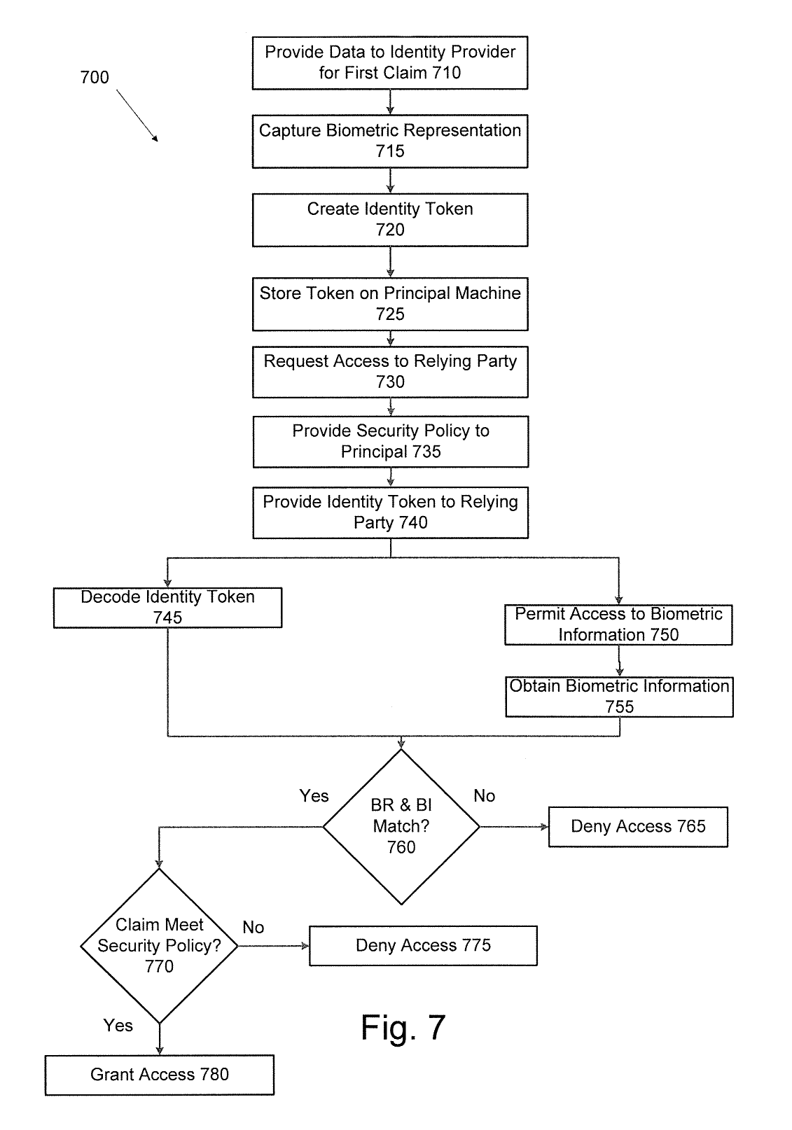

FIG. 7 illustrates an example method with reference to the example identity system 600 of FIG. 6 and the example identity token of FIG. 3. In this nonlimiting example method, principal 10 is an individual who wishes to purchase alcohol from relying party 120. Relying party 120 is a liquor store, including a human operator 122 (e.g., sales clerk). Principal 110 first must verify to an identity provider 115 that he/she is over 21 years of age. This can be done, for example, at any point prior to principal 110 attempting to purchase alcohol from relying party 120. Principal 110 provides 710 data to identity provider 115 to validate his/her claim that he/she is over 21 years of age. In this example, identity provider could be a government agency, and validating data provided could include a driver's license or passport.

At operation 715, identity provider 115 captures a biometric representation 158 of the principal 110. In this example, the biometric representation 158 is a photograph of principal 110. Identity provider 115 then creates 720 an identity token 150, including digitally signing the first claim 156 (e.g., Age>21=TRUE) and the biometric representation 158 in the manner previously described. In this example, the identity token is created 720 even before the relying party 120 requests it. In addition, the identity token 150 is stored 725 on the principal machine 111—in this example, a smart card. In some example embodiments, neither the identity token 150, the verifying data, nor biometric representation provided by principal 110 is stored by the identity provider 115. Rather, in this example, the identity token exists only on the principal machine 111. Because the principal machine 111 is under control of the principal 110, the principal 110 may appreciate that his/her personal information is not part of a central database of other persons' personal information. In addition, any claims information contained on principal machine 111 can be encrypted to prevent access by others. Even if someone else accessed the claims information in token 150, because the claim(s) are digitally signed to a photograph of principal 110, the claims would be useless with any relying party utilizing the methods of verification set forth herein.

Principal 110 requests access 730 to the relying party 120. In the present example, the principal 110 requests the ability to buy alcohol from relying party 120. Relying party 120 provides 735 the principal 110 with its security policy. In this example, relying party's 120 security policy could include requiring the principal 110 to provide relying party 120 an identity token 150 from identity provider 115 that includes (a) a claim that principal 110 is of sufficient age; and (b) a biometric representation 158 of principal 110, such as a picture. Principal 110 then provides 740 identity token 150 from principal machine 111 to relying party 120 through a first channel 175. In this example, the first channel 175 includes an operative connection (direct or wireless) between principal machine 111 and relying party machine 126. This could include connecting (either directly or wirelessly) the smart card (principal machine 111) to relying party machine 126. For instance, relying party machine 126 could include a peripheral smart-card reader. The principal 110 is then prompted through a user-interface on relying party machine 126 to select an identity token stored on principal machine 111. The principal 110 selects the appropriate identity token 150 and sends the identity token to the relying party machine 126. In exemplary embodiments, sending the identity token to the relying party machine could also include allowing the relying party machine to access the identity token from its location on the principal machine 111. Relying party machine 126 then decodes and displays 745 (for example, on a monitor attached to relying party machine 126) the token 150 so that the human operator 122 can see the biometric representation 158 (e.g., picture of the principal 110).

Principal 110 also provides 750 relying party 120 access to biometric information 179 through a second channel 180. In this case, the second channel 180 is an in-person observation of principal 110, and the principal 110 provides that access by physically being present at the location of relying party 120. Relying party 120 obtains 755 biometric information 179 about principal 110. In this example human operator 122 views the principal 110 in person. In other embodiments, relying party 120 may collect biometric information 179 about the principal 110 by asking the principal 110 to speak, or subject himself/herself to a fingerprint scan or iris scan, for example, depending on what biometric representation relying party has to compare against. Either of steps 750 or 755 can occur prior to, after, or in parallel with step 745.

Relying party 120 determines 760 whether the biometric information 179 and biometric representation 158 match. In this example, the human operator 122 (e.g., clerk at the liquor store) determines if the principal 110 physically in the store is the same person depicted in the picture included with the identity token 150. If not, the relying party denies 765 the principal 110 access (e.g., the clerk refuses to sell liquor to the principal 110). If there is a match between the biometric information 179 and biometric representation 158, the relying party 120 determines 770 whether the first claim 156 meets the security policy of the relying party 120. If so, the principal 110 is granted 780 access (e.g., the ability to purchase alcohol). If not, access is denied 775. In other embodiments, operations 760 and 770 may occur in a different order or in parallel with each other.

Although the original verification of principal 110's identity could still be compromised by forged documents presented to identity provider 115, if identity provider 115 is more skilled at verifying documents such as passports and drivers' licenses than the relying party 120, the overall reliability of this system is still improved. For example, the system and method described in FIGS. 6 and 7 eliminates the need for human operator 122 of relying party 120 (e.g., clerk at a liquor store) to recognize such forgeries.

In another example embodiment, biometric representation 158 may comprise a fingerprint scan, an iris scan, a voice sample, or other biometric data from principal 110. In those situations, biometric information 179 collected by second channel 180 would change accordingly. For instance, if biometric representation 158 comprised a fingerprint scan in the example embodiment illustrated in FIGS. 6 and 7, the human operator 122 may ask principal 110 to place his/her finger on a fingerprint scanner that is part of relying party machine 126. In this instance, the biometric information 179 is the fingerprint scan collected by the human operator 122, and the comparison between biometric information 179 and biometric representation 158 may be performed by relying party machine 126. Where other types of biometric representations 158 are collected by identity provider 115, correlative changes in the collection of biometric information 179 are also contemplated.

In another embodiment, relying party 120 may comprise an automatic vending machine. For example, a vending machine selling alcohol would still require proof that a principal 110 attempting to purchase alcohol is of sufficient age. In this exemplary embodiment, human operator 122 need not be physically present at the vending machine. Rather, the vending machine of relying party 120 could be equipped with a camera or other transponder to transmit biometric information 179 to a display device for human operator 122. In this manner, human operator 122 could service multiple vending machines from a central location. In this embodiment, the vending machine of relying party 120 could act as the relying party machine 126 to receive and decode the identity token 150 in the manner described.

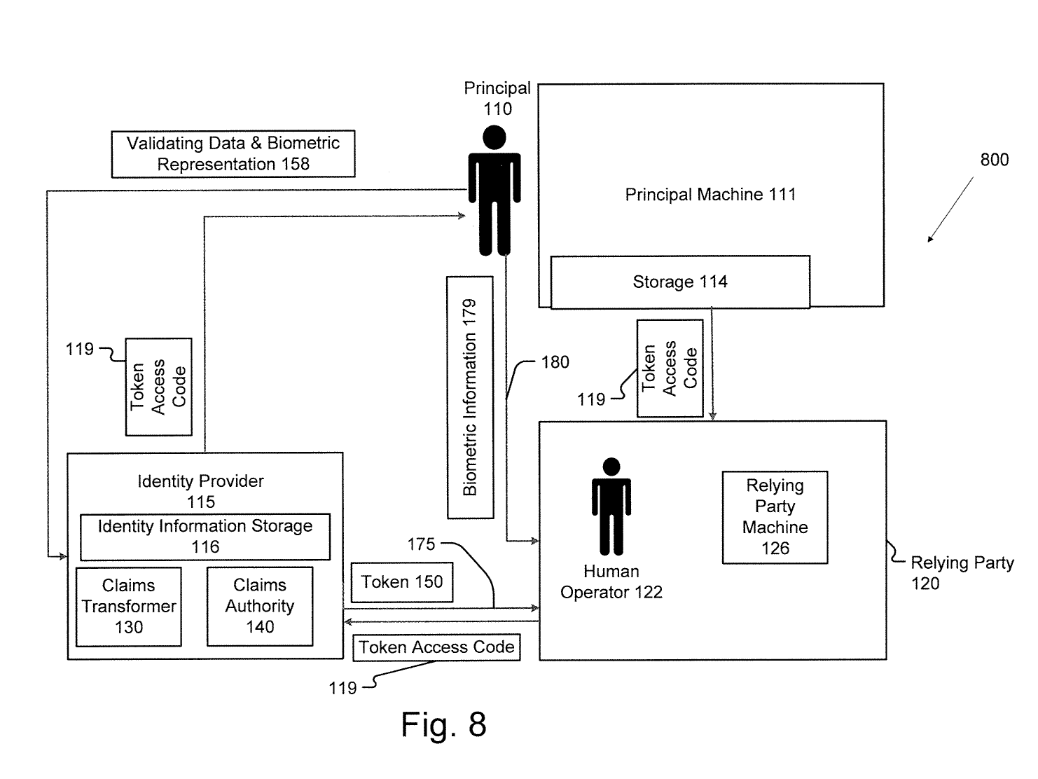

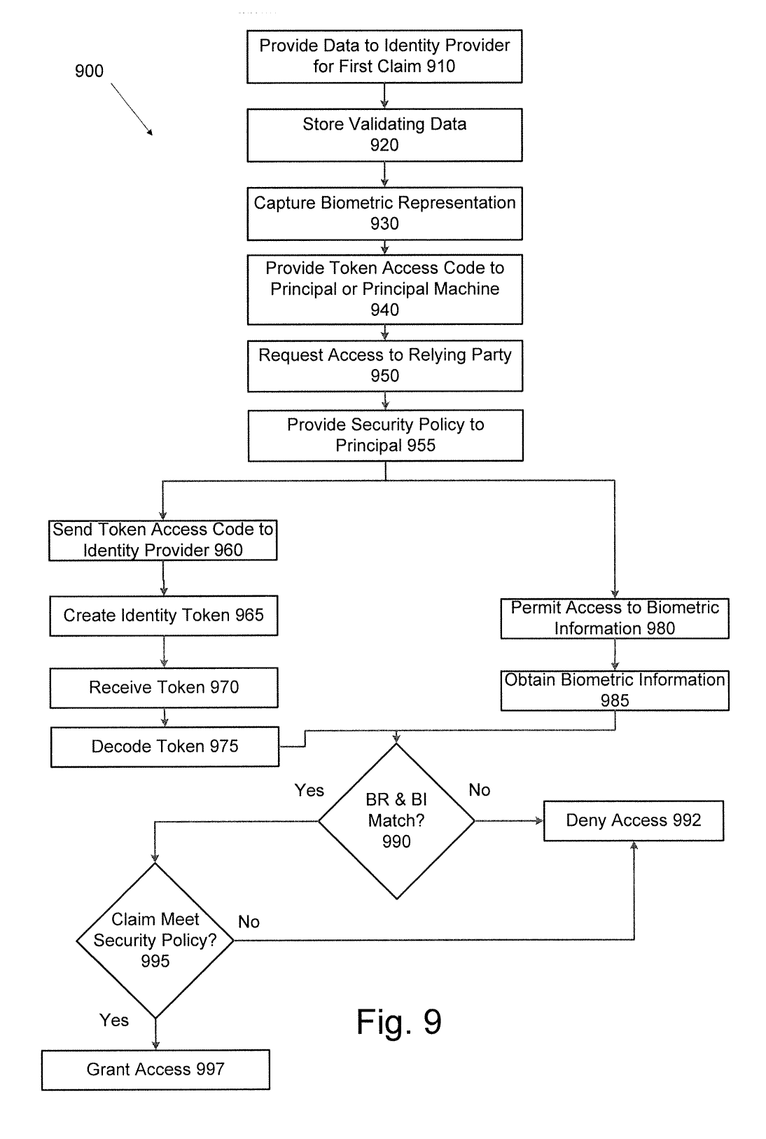

The system and method described in relation to FIGS. 6 and 7 are most useful when the subject of the claim is a static piece of information (e.g., age, gender, etc.) because a principal can have such data verified once by an identity provider and carry a token on a principal machine that includes that claim. In other words, the claim will never go stale. For more fluid information, however, verification needs to be updated. For example, assume a relying party has a security policy that requires a principal to prove that he/she has a credit score over a certain minimum. Because credit scores change over time, it may not be sufficient for a principal to store an identity token with a claim as to his/her credit score for later use. However, it would still be useful for a relying party to have the additional assurance of a biometric representation/biometric information comparison. In addition, a principal will still find beneficial the ability to control the dissemination of personal information, such as his/her credit score. The system and method illustrated in relation to FIGS. 8 and 9 are useful for, among other things, the situation described.

Referring now to FIG. 8, another example identity system 800 is described. Identity provider 115 includes identification information storage 116. Principal 110 again has control or possession of principal machine 111. Principal machine 111 may be, in this nonlimiting example, a portable computing device, such as a smart card having storage and computing capability. Relying party 120 includes a relying party machine 126 and a human operator 122.

Referring now to FIG. 9, an example method 900 is described in relation to the system illustrated in FIG. 8 and the example identity token of FIG. 3. In this example, relying party 120 is a vendor, such as a car dealer, having a physical location. Human operator 122 is a relying-party employee, such as a financing specialist. In order to purchase a car from relying party 120, according to relying party's security policy, principal 110 must establish that his/her credit score exceeds a certain minimum.

Principal 110 presents 910 data to identity provider 115. In this example, data presented by principal 110 to identity provider 115 is not necessarily the same information that will be the subject of a claim in a security token. For example, principal 110 may present identifying information to identity provider 115 to allow identity provider 115 to run a credit check on principal 110 at some later time. Identity provider 115 stores 920 the information provided by principal 110 in identity provider storage 116. Identity provider 115 also captures 930 a biometric representation 158 of principal 110 in the manner previously described. For the purposes of this example, the biometric representation 158 is a picture of the principal 110.

Identity provider 110 then provides 940 an identity token access code 119 to principal 110 and/or principal machine 111. For example, identity provider 115 can provide principal 110 a personal identification number (PIN) that principal 110 can use later to obtain an identity token in response to a relying party's security policy. Identity provider 115 can also provide the identity token access code 119 to principal machine 111 for electronic storage in storage 114 so that principal 110 does not need to remember the identity token access code 119 later.

Steps 910, 920, 930, and 940 can be performed at any point prior to principal 110 requesting 950 access to relying party 120. In this example, requesting access 950 comprises principal 110 attempting to purchase a car from the relying party 120 (car dealer). Relying party 120 provides 955 principal 110 with its security policy. In this example, the relying party 120 requires an identity token 150 from an identity provider, such as identity provider 115, that includes: (a) a biometric representation 158 of principal 110, and (b) a first claim 156 that principal 110 has a credit rating that exceeds a defined minimum.

Principal 110 provides the identity token access code 119 (e.g., PIN) to the identity provider 115. This can be accomplished either directly or through a relying party machine 126. For example, principal 110 can call a representative of identity provider 115 via a telephone connection and provide the identity token access code 119 verbally. Alternatively, principal machine 111 can initiate communication with the identity provider 115 (e.g., where principal machine 111 has wireless communication capacity). In still other embodiments, relying party 120 may provide access to a relying party machine 126 where principal 110 can type in his identity token access code 119 or where the identity token access code 119 can be read/scanned from principal machine 111 (e.g., by an infrared scanner included in relying party machine 126). In some embodiments, principal machine 111 may store several information cards; when the principal machine 111 is scanned by relying party machine 126, a user interface is launched that permits the principal 110 to choose the information card containing the identity token access code 119 issued by identity provider 115. The relying party machine 126 is then programmed to request an identity token 150 from identity provider 115 using the identity token access code 119.

Upon receiving the identity token access code 119, identity provider 115 creates 965 an identity token 150. In this example, identity provider 115 uses the information stored at step 920 to validate the first claim 156, i.e., the principal 110 has a credit score exceeding a predetermined minimum. For example, the identity provider 115 may use identifying information stored at step 920 to access credit history files at a third-party credit agency. Alternatively, if identity provider 115 is the credit agency, identity provider 115 can calculate the credit score of principal 110 directly. Upon verifying that the principal 110 has a credit score exceeding the predetermined minimum, identity provider 115 binds that first claim 156 to the biometric representation 158 captured at step 930 to create an identity token 150 in the manner previously described. In this case, the first claim 156 included in identity token 150 may be a simple statement that CREDIT SCORE>MINIMUM. In this way, principal 110 need not reveal his/her exact credit score to relying party 120 nor any of the underlying transactions that relate to that credit score. The identity token 150 is digitally signed by identity provider 115 to bind the first claim 156 and biometric representation together.

At step 970, the identity token 150 is received through a first channel 175. The identity token 150 can be received either at relying party machine 126 or principal machine 111. The identity token 150 is then decoded 975 to display the biometric representation 158 and content of the first claim 156. If (as shown) the identity token 150 is received 970 at the relying party machine 126, the relying party machine 126 can decode 975 the token for use by human operator 122. If, alternatively, identity token 150 is received 970 at principal machine 111, principal machine 111 can decode 975 the identity token 150 itself or pass the identity token 150 to the relying party machine 126. For instance, the principal machine 111 can receive identity token 150 via a wireless communications link, pass the identity token 150 to relying party machine 126 (e.g., via infrared scan), where the identity token 150 is decoded.

Principal 110 also provides 980 relying party 120 access to biometric information 179 through a second channel 180. In this case, the second channel 180 is an in-person observation of principal 110, and the principal 110 provides 980 that access by physically being present at the location of relying party 120. Relying party 120 collects 985 biometric information 179 about principal 110 in this example by human operator 122 viewing the principal 110 in person. In other embodiments, relying party 120 may collect biometric information 179 about the principal 110 by asking the principal 110 to speak, or subject himself/herself to a fingerprint scan or iris scan, for example, depending on what biometric representation 158 relying party 120 has to compare against. Steps 980 and 985 can occur in parallel with, before, or after, any of steps 950, 955, 960, 965, 970, and 975.

Relying party 120 determines 990 whether the biometric information 179 and biometric representation 158 match. In this example, the human operator 122 (e.g., financing specialist at the car dealer) determines 990 if the principal 110 physically in the dealership is the same person depicted in the picture included with the identity token 150. If not, the relying party 120 denies 992 the principal 110 access (e.g., the financing specialist refuses to allow the principal 110 to purchase the car). If there is a match between the biometric information 179 and biometric representation 158, the relying party 120 determines 995 whether the first claim 156 meets the security policy of the relying party 120. If so, the principal 110 is granted 997 access (e.g., the ability to purchase the car). If not, access is denied 992. In other embodiments, operations 990 and 995 may occur in a different order or in parallel with each other.

Although example embodiments shown herein illustrate an identity token that is forwarded by an identity provider to a principal and then on to a relying party, in alternative embodiments the identity token can be forwarded directly from the identity provider to the relying party. For example, in some embodiments, one identity token including a computational token (and possibly a display token) can be forwarded to the relying party, and another identity token including a display token (and possibly the computational token) can be forwarded to the principal. Other configurations are possible.

Although the example embodiments shown herein illustrate a security policy requiring only a single claim and a single identity token issued by one identity provider, in other embodiments a policy can require multiple claims, and one or more identity providers can issue one or more identity tokens with one or more claims to satisfy the policy.

Although example embodiments shown utilize humans to perform comparisons between biometric information and biometric representations, in other embodiments, systems and methods for computer comparisons between biometric information and biometric representations can be used. For example, fingerprint, iris-scan, and facial-feature technologies can be used to perform comparisons between biometric representations and biometric information.

The various embodiments described above are provided by way of illustration only and should not be construed as limiting. Those skilled in the art will readily recognize various modifications and changes that may be made to the embodiments described above without departing from the true spirit and scope of the disclosure or the following claims.

1. A method for satisfying a security policy, comprising the steps of:
receiving an identity token from a principal through a first channel, wherein the identity token comprises at least a first claim and a biometric representation and wherein the first claim and the biometric representation are bound by a digital signatures;
obtaining biometric information about the principal through a second channel; and
determining the validity of the first claim at least in part by comparison of the biometric information to the biometric representation.

2. The method of claim 1, wherein the first claim and the biometric representation are digitally signed by a third-party identity provider.

3. The method of claim 1, wherein the second channel comprises in-person observation.

4. The method of claim 1, wherein the second channel comprises a substantially real-time electronic communication link.

5. The method of claim 4, wherein the step of obtaining includes the substep of:
challenging the principal to perform an unpredictable action that can be observed through the communication link.

6. The method of claim 1, wherein the step of receiving an identity token from a principal comprises receiving the identity token from a third party at the direction of the principal.

7. The method of claim 1, further including, prior to the step of receiving, the step of sending an identity token access code to a third party.

8. The method of claim 1, wherein the determining step comprises a human comparing the biometric information to the biometric representation.

9. A method for issuing an identity token, comprising:
verifying at least a first claim about a principal;
collecting a biometric representation of the principals;
creating at least a first identity token, including binding the first claim and the biometric representation with a digital signature.

10. The method of claim 9, further comprising the additional step of:
storing the first identity token on a principal machine.

11. The method of claim 10, wherein the principal machine comprises a portable computing device.

12. The method of claim 9, wherein the content of the first identity token is limited to minimally satisfy a security policy of a relying party.

13. The method of claim 9, further comprising the step of:
sending the first identity token to a third party.

14. The method of claim 9, wherein the verifying step includes verifying a second claim about the principal, and wherein the first identity token does not include the second claim.

15. The method of claim 9, including the further steps of:
generating an identity token access code; and
receiving the identity token access code prior to the step of creating the first identity token.

16. A computer-readable medium having computer-executable instructions for performing steps comprising:
requesting an identity token, wherein the identity token includes at least a first claim and a biometric representation of a principal and wherein the first claim and the biometric representation are bound by a digital signature;
sending the identity token to a relying party through a first channel;
providing the relying party access to biometric information about the principal through a second channel.

17. The computer-readable medium of claim 16 having further computer executable instructions for performing, prior to the step of requesting, the steps of:
attempting to access the relying party; and
receiving a security policy from the relying party.

18. The computer-readable medium of claim 17, wherein the content of the identity token is limited to satisfy only the security policy.

19. The computer-readable medium of claim 16, wherein the sending step comprises directing an identity provider to send the identity token to the relying party.

20. The computer-readable medium of claim 16, wherein the providing access step comprises activating a transponder to participate in a substantially real-time communications link with the relying party.
